(19) United States
(12) Patent Application Publication
(10) Pub. No.: US 2013/0105668 A1
(43) Pub. Date: May 2, 2013

(54) REFLECTIVE DISPLAY DEVICE WITH LIGHT COMPENSATION MODULE

(71) Applicants: HSIEN-LUNG HO, Tu-Cheng (TW); CHIU-HSIUNG LIN, Tu-Cheng (TW)

(72) Inventors: HSIEN-LUNG HO, Tu-Cheng (TW); CHIU-HSIUNG LIN, Tu-Cheng (TW)

(73) Assignee: HON HAI PRECISION INDUSTRY CO., LTD., Tu-Cheng (TW)

(21) Appl. No.: 13/330,534

(22) Filed: Dec. 19, 2011

(30) Foreign Application Priority Data
Nov. 2, 2011 (TW) 100139874

(51) Int. Cl. G01J 1/44

(52) U.S. Cl. 250/214 AL

(57) ABSTRACT

A display device includes a display layer, a control unit, a color sensor and a light guide plate (LGP) arranged on the display layer. A light emitting module includes three light emitters configured for emitting red, green and blue light, into the LGP through the lateral surface. The control unit determines whether the detected intensities of the red, green and blue light components in the ambient light are in a predetermined proportion, and to turn on the corresponding light emitters to compensate the red, green or blue light so as to maintain the intensities of the red, green and blue light components in the ambient light to be in the predetermined proportion.

### BACKGROUND

1. Technical Field

The present disclosure relates to a reflective display device, especially to a reflective display device with light compensation module.

2. Description of Related Art

Reflective displays, such as electrophoretic paper display (EPD), cholesteric liquid crystal display (ChLCD), electrowetting display (EWD) or interferometric modulator display (IMOD) are preferred over a traditional liquid crystal display (LCD) because of having a better reflectivity and contrast ratio. In these reflective displays, the ChLCD and the IMOD are capable of displaying colorful images, and the EPD are capable of displaying colorful images in two ways: one is to control each pixel to display a desired color by primary color mixing, such as RGB color mixing or YMC color mixing; and another is to cover the EPD with a color filter.

The reflective displays display by using reflecting ambient light. When the ambient light is weak, it is difficult to view the content displayed on the reflective displays. Furthermore, in certain conditions, the color balance of the reflective displays are limited, like reading under a sodium lamp, the ambient light is yellowish, or reading under a red neon light, the ambient light is reddish. The quality of image displayed on the reflective displays depends largely on the ambient light factors, which will be negatively affected.

Therefore, what is needed is reflective display device with light compensation module alleviating the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a reflective display device with a light compensation unit in accordance with a first exemplary embodiment.

FIG. 2 is a schematic, a cross-sectional view showing a display layer of the reflective display device of FIG. 1.

FIG. 3 is an isometric view showing the light compensation unit of the reflective display device of FIG. 1.

FIG. 4 is a block diagram of the reflective display device with a light compensation unit in accordance with a first exemplary embodiment.

FIG. 5 is a cross-sectional view of the light paths of the light compensation unit of the reflective display device of FIG. 1.

FIG. 6 is an isometric view showing a light compensation unit of the reflective display device in accordance with a second exemplary embodiment.

FIG. 7 is an isometric view showing a light compensation unit of the reflective display device in accordance with a third exemplary embodiment.

FIG. 8 is an isometric view showing a light compensation unit of the reflective display device in accordance with a fourth exemplary embodiment.

FIG. 9 is an isometric view showing a light compensation unit of the reflective display device in accordance with a fifth exemplary embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

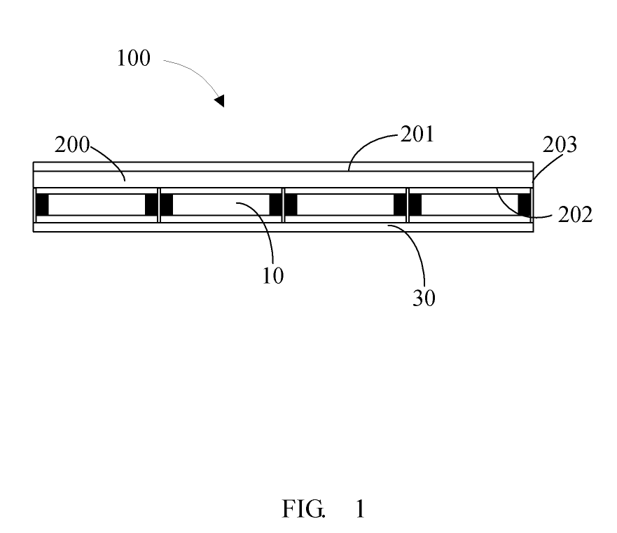

Referring to FIG. 1, a first embodiment of a reflective display device 100 with a light compensation unit is illustrated. The reflective display device 100 includes a display layer 10, a light guide plate (LGP) 200, a substrate 30, and a power unit (not shown). The display layer 10 is arranged between the LGP 20 and the substrate 30. In the first embodiment, the display layer 10 is constructed using interferometric modulator display (IMOD) technology.

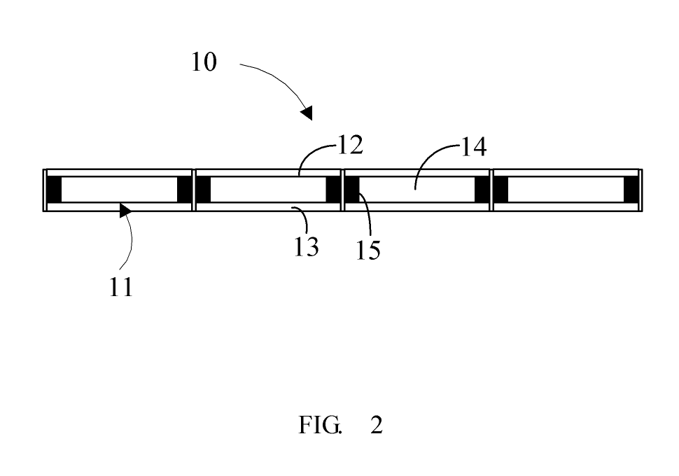

Referring to FIG. 2, the display layer 10 includes a pixel array. Each pixel includes three sub-pixels 11. Each sub-pixel 11 includes a micro-electro-mechanical system (MEMS) interferometric modulator. In this embodiment, each sub-pixel 11 includes a pair of reflective layers, a reflective membrane 12 and a movable reflective membrane 13 spaced a variable and controllable distance from each other, which forms a resonant optical chamber 14 with at least one variable dimension. The reflective membrane 12 and the movable reflective membrane 13 are separated from each other by spacers 15.

Light reflected by the reflective membrane 12 and the movable reflective membrane 13 can be observed from a viewing direction. The hue of light reflected by the sub-pixel 11 is depended upon the optical path length between the reflective membrane 12 and the movable reflective membrane 13. Namely, the distance between reflective membrane 12 and the movable reflective membrane 13 determines the hue of light reflected by the sub-pixel 11. The three sub-pixels 11 of each pixel are capable of respectively reflecting light of the three primary colors (red, green and blue). The hue generated by a pixel will be determined by the mixing of red, green, and blue light reflected by the three sub-pixels.

As will be apparent from the following description, the reflective display device 100 may be implemented in any device that is configured to display an image, whether in motion (e.g., video) or stationary (e.g., still image), and whether textual or pictorial. More particularly, it is contemplated that the reflective display device 100 may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, displaying camera views (e.g., display of a rear view camera in a vehicle), electronic photographs, electronic billboards or signs, projectors, architectural structures (e.g., the layouts), packaging, and aesthetic structures (e.g., display of images on a piece of jewelry).

In other embodiments, the display layer 10 can be an E-paper display unit including a color filter and an electrophoretic paper layer.

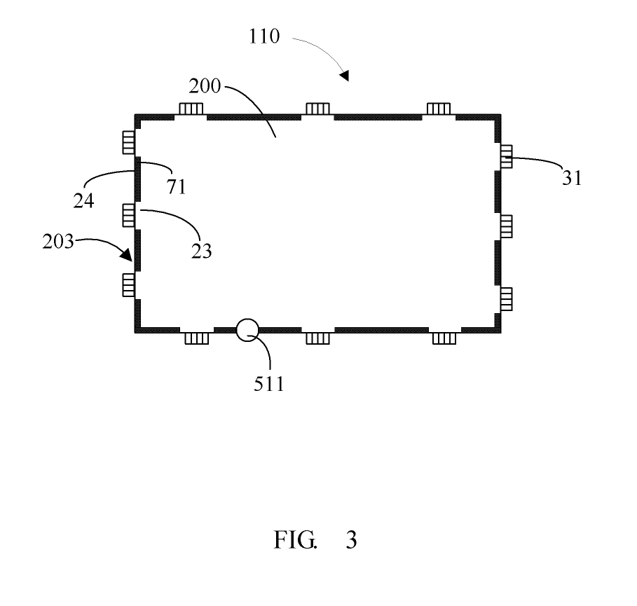

Referring to FIG. 3, the LGP 200 is arranged on the display layer 10 and includes a first surface 201 away from the display layer 10, an opposite, second surface 202 and a lateral surface 203 between the first and second surfaces 201, 202. The LGP 200 is transparent and may be made of plastic or glass, such as polymethyl methacrylate (PMMA). The lateral surface 203 of the LGP 200 includes a light incident portion 23 and a light reflection portion 24, a reflection film 71 applied on the light reflecting portion 24. The light beams reaching the reflection film 71 will be reflected back, and will not be scattered or lost. The reflection film 71 can be a metal reflective coating chosen from the group consisting of an aluminum coating, a gold coating and a silver coating.

Referring to FIG. 3, a light compensation unit 110 is illustrated. In a first embodiment, the LGP 200 is rectangular. The light compensation unit 110 includes at least one light emitting module 31 arranged on one or more sidewalls of the LGP 200. In this embodiment, the light emitting modules 31 are arranged on all four sidewalls of the LGP 200. The light emitting modules 31 are connected with a power supply (not shown). In this embodiment, each light emitting module 31 includes four LED emitters capable of respectively emitting red, green, blue and white light. The light beams emitted by the light emitting modules 31 enter into the LGP 200 through the incidence portion 23 on the lateral surface 203 of the LGP 200.

The light compensation unit 110 further includes a color sensor 511. In this embodiment, the color sensor 511 is arranged on the first surface 201 closed to the lateral surface 203 of the LGP 200. The color sensor 511 can be a bipolar complementary metal oxide semiconductor (BiCMOS) color sensor that is often used in applications like white balancing, color measurement and TFT monitor backlight control. This BiCMOS color sensor is formed by three vertically stacked photodiodes—a shallow diode for blue, a middle diode for green and a deep diode for red light, and is capable of detecting the intensity of the red, green and blue light in ambient light.

In the first embodiment, the color sensor 511 is arranged on the first surface 201 of the LGP 200. The color sensor 511 can be formed by film-printing process or semiconductor processing technology, including the steps of printing a number of circuit layers and a number of photodiodes layers on the surface of the LGP 200 in a proper order. The material of the circuit layer is transparent, e.g., the circuit layer can be made of indium tin oxide (ITO). In another embodiment, the color sensor 511 can be arranged on the surface of the display layer 10 facing the viewing direction, via the manufacturing processes described above.

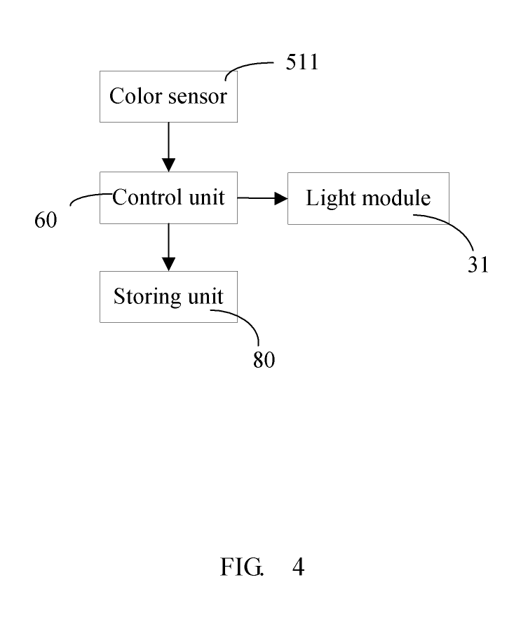

Referring to FIG. 4, the reflective display device 100 further includes a control unit 60 and a storage unit 80 storing a predetermined proportion of the red, green and blue light in normal ambient light. As described above, in a pixel, the hue generated by a pixel is determined by of the mixed color of the three primary colors light reflected by the sub-pixels 11. Usually, when the intensity of the red light is 21 percent, the green light is 69 percent and the blue light is 10 percent, the mixed light is pure white. The predetermined proportion of the red, green and blue light in ambient light can be defined as 69:21:10. In other embodiment, the white light can be defined as a mixed red, green and blue light in equal proportions and the predetermined proportion of the red, green and blue light in ambient light can be defined as 1:1:1.

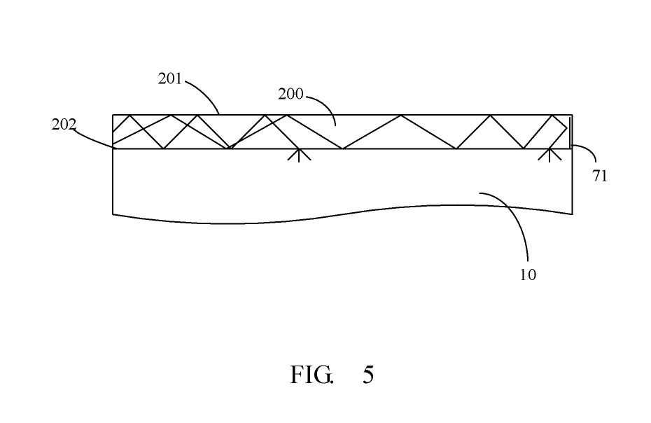

Referring to FIG. 5, the color sensor 511 detects the intensities of each of the red, green and blue light components in ambient light, then converts the detected intensities of the red, green and blue light into electronic signals and sends the electronic signals to the control unit 60. The control unit 60 determines the intensities of each of the red, green and blue light components in ambient light according to the electronic signals. The control unit 60 further determines that whether the detected intensities of the red, green and blue light components in the ambient light are in the predetermined proportion, and to turn on the corresponding light emitters of light emitting modules 31 to compensate the red, green or blue light so as to maintain the intensities of the red, green and blue light components in the ambient light to be in the predetermined proportion.

For example, if the proportion of the detected intensity of the red, green and blue light in ambient light is 10%, 20% and 20%, and the predetermined proportion of the red, green and blue light components in a normal ambient light is defined as 1:1:1. The control unit 60 determines the intensity ratio of the red, green and blue light components in ambient light is in 0.5:1:1 according to the electronic signals sent by the color sensor 511, and determines that the red light is below the value in the predetermined proportion. The control unit 60 then turns on the red LED emitter of the light emitting modules 31. The red light beams emitted by the red LED emitter enter the LGP 200 from the light incident portion 23, and are internally reflected multiple times between the first surface 201 and the second surface 202 and ultimately reach the display layer 10. The light reaching the display layer 10 includes ambient light and the red light emitted by the red LED emitter. The red light beams compensate the insufficient intensity proportion of the red light in ambient light. The mixing of the ambient light and the red light emitted by the red LED emitter provides a white light having a color closer to pure white, which facilitates to improve the color balance of the image displayed on the reflective display device 100.

In this embodiment, the control unit 60 determines the intensity of the red, green and blue light in ambient light according the electronic signals, then further determines that whether the average of the detected intensity of the red, green and blue light is below a preset value. If so, the control unit 60 determines that the ambient light is weak and turns on the white LED emitter of the light emitting module 31. The light beams emitting from the white LED emitter enter the LGP 200 from the light incident portion 23, and are internally reflected multiple times between the first surface 201 and the second surface 202 and ultimately reach the display layer 10. so the display layer 10 can be illuminated more homogeneously when the ambient light is weak.

In other embodiments, the control unit 60 may determine whether the ambient light is weak by comparing the greatest of the detected intensity of the red, green and blue light with the preset value.

In other embodiments, the color sensor 511 may include a light sensor which is capable of detecting the intensity of the ambient light and signaling the control unit 60 if the intensity of the ambient light is below an preset values. The control unit 60 can then determine whether the ambient light is weak.

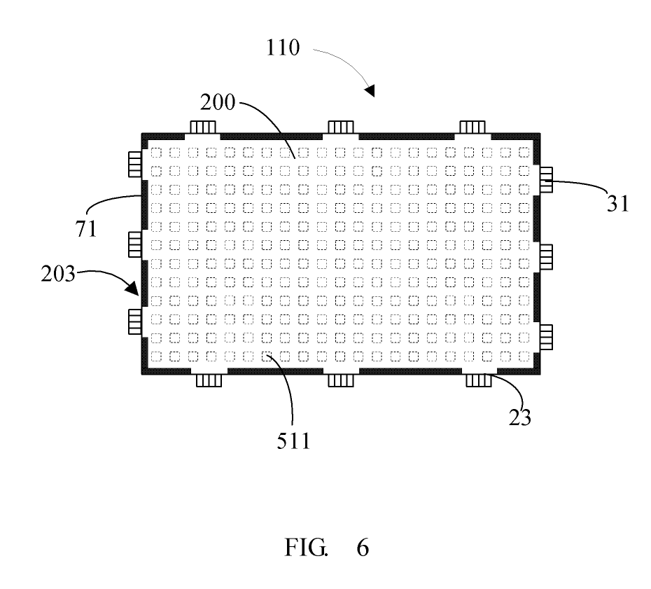

Referring to FIG. 6, a light compensation unit 111 according to a second embodiment is illustrated. The light compensation unit 111 is similar to the light compensation unit 110 described in the first embodiment. The difference between the light compensation unit 111 and 110 is relative to the position and the number of the color sensor 511. In the second embodiment, an array of color sensors 511 is disposed on the surface of the display layer 10 facing the view direction.

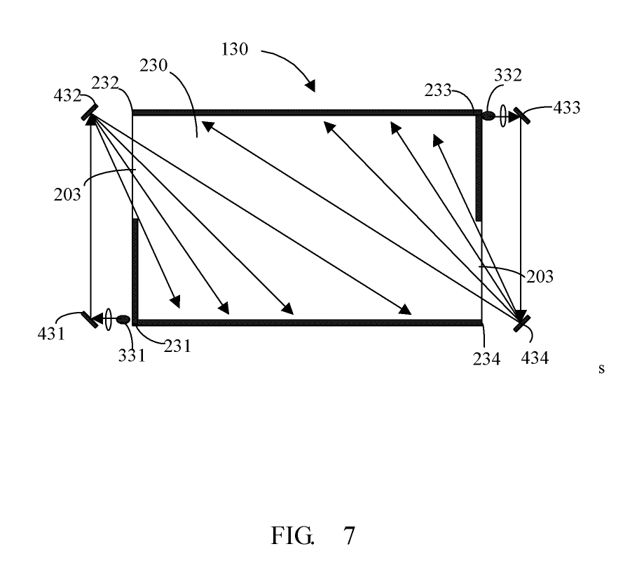

Referring to FIG. 7, a light compensation unit 120 employed in the reflective display device 100 according to a third embodiment is illustrated. The light compensation unit 120 is similar to light compensation unit 110 described in the first embodiment. The difference between the light compensation unit 120 and 110 is that the light compensation unit 120 includes two light emitting modules 321, 322 arranged on first diagonally-opposite corners of a LGP 220, and two scanning mirrors 421, 422 arranged on the other two corners of the LGP 220. Similar to the first embodiment, each of the light emitting modules 321, 322 includes four LED emitters capable of respectively emitting red, green, blue and white light. The scanning mirrors 421, 422 are biaxial Micro-Electro-Mechanical System (MEMS) scanning mirrors that have three-dimensional scanning ability, and can reflect light beams.

The light beams emitted by the light emitting module 321 can travel to the scanning mirror 421, and are reflected by the scanning mirror 421. The reflected light beams travel in different directions (in three dimensions) because of the tilting of the reflection plane of the scanning mirror 421. The reflected light beams then enter the LGP 220 through the incidence portion 223 defined on the lateral surface of the LGP 220. In a similar way, the light beams emitted by the light emitting module 322 are reflected by the scanning mirror 42, and the reflected light beams enter the LGP 220 through the incidence portion 223.

In the third embodiment, a condenser lens 620 is arranged between the light emitting module 321 and the scanning mirror 421, to focus the light beams emitted by the light emitting module 321. Similarly, a condenser lens 620 is arranged between the light emitting module 322 and the scanning mirror 422. In other embodiments, the light emitting modules 321, 322 can be a laser light emitter, and in that case, the condenser lens 620 can be omitted because the light from a laser light emitter is coherent and condensed in any event.

A reflection film 72 is applied on each sidewall of the LGP 220 except for the incidence portion 223. The light beams reaching the reflection film 72 will be reflected back, and will not be scattered or lost. The reflection film 72 can be a reflective metal coating.

In the third embodiment, the light compensation unit 120 includes a color sensor 521 arranged on the first surface (not labeled) closed to the lateral surface (not labeled) of the LGP 220. The color sensor 521 detects intensities of each of the red, green and blue light components in ambient light, then converts the detected intensities of the red, green and blue light into electronic signals and sends the electronic signals to the control unit 60. The control unit 60 determines the intensities of the red, green and blue light components in ambient light according the electronic signals. The control unit 60 further determines that whether the detected intensities of the red, green and blue light components in the ambient light are in the predetermined proportion, and to turn on the corresponding light emitters of light emitting modules 321, 322 to compensate the red, green or blue light so as to maintain the intensities of the red, green and blue light components in the ambient light to be in the predetermined proportion.

Also taking as an example, if the proportion of the detected intensity of the red, green and blue light in ambient light is 10%, 20% and 20%, and the predetermined proportion of the red, green and blue light components in a normal ambient light is defined as 1:1:1. The control unit 60 determines the intensity ratio of the red, green and blue light components in ambient light is in 0.5:1:1 according to the electronic signals sent by the color sensor 521, and determines that the proportion of the detected intensity of the red light is below the value in the predetermined proportion. The control unit 60 then turns on the red LED emitter of the light emitting modules 321, 322. The red light beams emitting from the red LED emitter of the light emitting modules 321 and 322 are reflected by the scanning mirrors 421 and 422 respectively. Then the reflected light beams enter the LGP 220. The red light beams are internally reflected multiple times in the LGP 220 and ultimately reach the display layer 10. The red light emitting from the red LED emitter of the light emitting modules 31 compensate the lack of the intensity proportion of the red light in ambient light and makes the color of ambient light is much closer to white.

Furthermore, as described in the first embodiment, in the third embodiment, the control unit 60 can determine whether the ambient light is weak. When the control unit 60 determines that the ambient light is weak, the white LED emitter of the light emitting modules 321, 322 is turned on by the control unit 60. The light beams emitting from the white LED emitter ultimately reach the display layer 10.

In another embodiment, the light emitting modules 321, 322, and the scanning mirrors 421, 422 are arranged on the lateral sides of the LGP 240. The number of the light emitting modules can be more than two, and the number of scanning mirrors is equal to that of the light emitting modules.

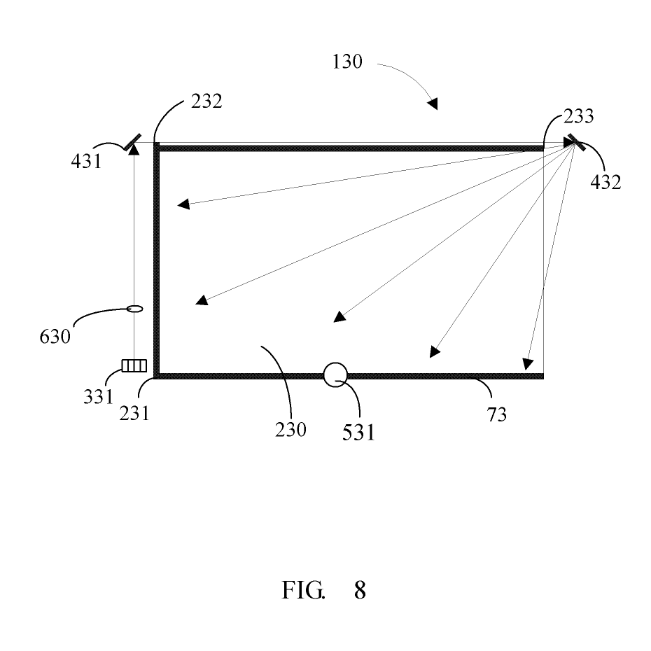

Referring to FIG. 8, a light compensation unit 130 employed in the reflective display device 100 according to a fourth embodiment is illustrated. The light compensation unit 130 is similar to light compensation unit 120 described in the third embodiment. An LGP 230 of the display device includes a first corner 231, a second corner 232 adjacent to the first corner 231 and a third corner 233 diagonally opposite the first corner 231. The difference between the light compensation unit 130 and 120 is that a light emitting module 331 is arranged on the first corner 231, and a first scanning mirror 431 is arranged on the second corner 232, and a second scanning mirror 432 is arranged on the third corner 233. Similar to the first embodiment, each of the light emitters 331 includes four LED emitters capable of respectively emitting red, green, blue and white light. In the fourth embodiment, the first scanning mirror 431 and the second scanning mirror 432 are uniaxial MEMS scanning mirrors that have a two-dimensional scanning ability, and can reflect light beams. The rotational axis of the first scanning mirror 431 is perpendicular to the rotational axis of the second scanning mirror 432.

The light beams emitted by the light emitting module 331 can travel to the first scanning mirror 431, and are reflected by the first scanning mirror 431. The reflected light beams travel in different directions (in two dimensions) because of the tilting of the reflection plane of the first scanning mirror 431. The reflected light beams are further reflected by the second scanning mirror 432 and travel in different directions (in three dimensions). Finally, the light beams enter the LGP 230 through the incidence portion (not labeled), which is defined on the lateral surface of the LGP 230. In this embodiment, a condenser lens 630 is arranged between the light emitting module 331 and the first scanning mirror 431, to focus the light beams emitted by the light emitting module 331.

In the fourth embodiment, the light compensation unit 130 includes a color sensor 531 arranged on the first surface (not labeled) closed to the lateral surface (not labeled) of the LGP 230. The color sensor 531 is capable of detecting the intensities of each of the red, green and blue light components in ambient light, then converts the detected intensities of the red, green and blue light into electronic signals and sends the electronic signals to the control unit 60. The control unit 60 determines the intensities of each of the red, green and blue light components in ambient light according the electronic signals. The control unit 60 further determines that whether the detected intensities of the red, green and blue light components in the ambient light are in the predetermined proportion, and to turn on the corresponding light emitters of light emitting module 331 to compensate the red, green or blue light so as to maintain the intensities of the red, green and blue light components in the ambient light to be in the predetermined proportion.

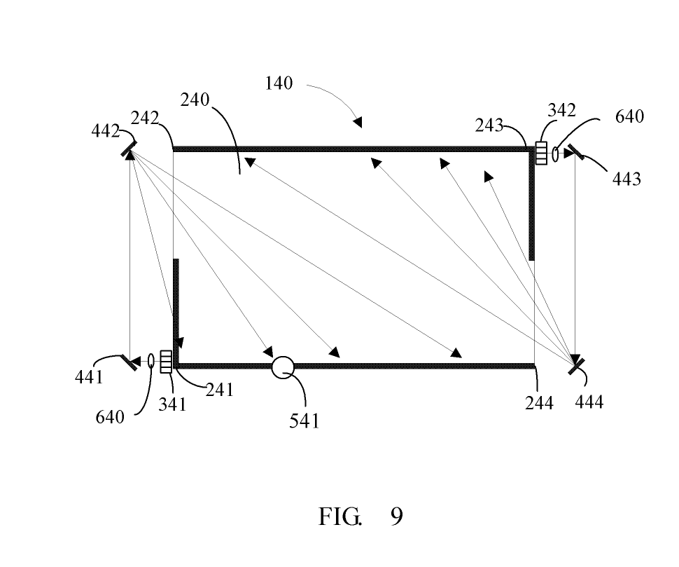

Referring to FIG. 9, a light compensation unit 140 employed in the reflective display device 100 according to a fifth embodiment is illustrated. The light compensation unit 140 is similar to light compensation unit 120 described in the third embodiment. An LGP 240 of the display device includes a first corner 241, a second corner 242 adjacent to the first corner 241, a third corner 243 diagonally opposite the first corner 241 and a fourth corner 244 diagonally opposite the second corner 242. The difference between the light compensation unit 140 and 120 is that a light emitting module 341 and a first scanning mirror 441 are arranged on the first corner 241, and a light emitting module 342 and a first scanning mirror 443 are arranged on the first corner 243. A second scanning mirror 442 is arranged on the second corner 242 and a second scanning mirror 444 is arranged on the fourth corner 244. Similar to the first embodiment, each of the light emitting modules 341, 342 includes four LED emitters capable of emitting light in one of four colors, red, green, blue and white. In the fourth embodiment, the first scanning mirror 441, 443 and the second scanning mirror 442,444 are uniaxial MEMS scanning mirrors. The rotational axis of the first scanning mirror 441 is perpendicular to the rotational axis of the second scanning mirror 442, and the rotational axis of the first scanning mirror 443 is perpendicular to the rotational axis of the second scanning mirror 444.

The light beams emitted by the light emitting module 341 can travel to the first scanning mirror 441, and are reflected by the first scanning mirror 441. The reflected light beams travel in different directions (in two dimensions) because of the tilting of the reflection plane of the first scanning mirror 441. The reflected light beams are further reflected by the second scanning mirror 442 and travel in different directions (in three dimensions). Finally, the light beams enter the LGP 240 through the incidence portion (not labeled) which is defined on the lateral surface (not labeled) of the LGP 240. Similarly, the light beams emitted from the light emitting module 342 are scanned and reflected twice, by the first scanning mirror 443 and by the second scanning mirror 444, and the reflected light beams travel in different directions (in three dimensions) and then enter the LGP 240. In this embodiment, a condenser lens 640 is arranged between the light emitting module 341 and the first scanning mirror 441, to focus the light beams emitted by the light emitting module 341. Similarly, a condenser lens 640 is arranged between the light emitting module 342 and the scanning mirror 443.

In the fifth embodiment, the light compensation unit 140 includes a color sensor 541 arranged on the first surface (not labeled) near the lateral surface (not labeled) of the LGP 240. The color sensor 541 is capable of detecting the intensities of each of the red, green and blue light components in ambient light, then converts the detected intensities of the red, green and blue light into electronic signals and sends the electronic signals to the control unit 60. The control unit 60 determines the intensities of each of the red, green and blue light components in ambient light according to the electronic signals. The control unit 60 further determines that whether the detected intensities of the red, green and blue light components in the ambient light are in the predetermined proportion, and to turn on the corresponding light emitters of light emitting modules 341, 342 to compensate the red, green or blue light so as to maintain the intensities of the red, green and blue light components in the ambient light to be in the predetermined proportion.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A reflective display device comprising:
a display layer;
a light guide plate (LGP) arranged on the display layer, the LGP comprising a first surface facing away from the display layer, an second, opposite surface, and a lateral surface between the first surface and the second surface;
a control unit;
a color sensor configured to detect an intensity of each of red, green and blue light components in ambient light;
a light emitting module comprising three light emitters configured for emitting red, green and blue light, into the LGP through the lateral surface;
the control unit configured to determine whether the detected intensities of the red, green and blue light components in the ambient light are in a predetermined proportion, and to turn on the corresponding light emitters to compensate the red, green or blue light so as to maintain the intensities of the red, green and blue light components in the ambient light to be in the predetermined proportion.

2. The reflective display device of claim 1, wherein the lateral surface of the LGP comprises a light incident portion and a light reflecting portion, a reflection film is applied on the light reflecting portion of the lateral surface, and light emitted by the light emitters enters the LGP through the incidence portion.

3. The reflective display device of claim 2, wherein the reflection film is a metal reflecting coating chosen from the group consisting of an aluminum coating, a gold coating and a silver coating.

4. The reflective display device of claim 1, wherein the light emitting module further comprises a white light emitter capable of emitting white light, the control unit determines whether the ambient light is weak, and turning on the white light emitter if the ambient light is weak.

5. The reflective display device of claim 4, wherein the control unit determines whether the ambient light is weak by determining whether the average of the intensities of the red, green and blue light is below a preset value.

6. The reflective display device of claim 4, wherein the control unit determines whether the ambient light is weak by comparing the greatest one of the intensities of the red, green and blue light with a preset value.

7. The reflective display device of claim 4, wherein the color sensor further comprises a light sensor capable of detecting an intensity of the ambient light, the control unit determines whether the ambient light is weak according to the intensity detected by the light sensor.

8. The reflective display device of claim 1, wherein the light emitting module comprises three LED emitters for respectively emitting red, green and blue light.

9. The reflective display device of claim 1, further comprising a scanning mirror arranged on the lateral surface of the LGP, the scanning mirror is configured to reflect and direct the light from the light emitting module to enter the LGP through the lateral surface;

10. The reflective display device of claim 9, wherein the scanning mirror is a micro-electro-mechanical system (MEMS) scanning mirror.

11. The reflective display device of claim 9, wherein the scanning mirror is a bi-axial MEMS scanning mirror.

12. The reflective display device of claim 9, wherein the scanning mirror comprises two uniaxial MEMS scanning mirrors, and rotating axes of the two scanning mirrors are perpendicular to each other.

13. The reflective display device of claim 9, wherein the lateral surface of the LGP comprises a light incident portion and a light reflecting portion, a reflection film is applied on the light reflecting portion of the lateral surface, and light emitted by the light emitters enters the LGP through the incidence portion.

14. The reflective display device of claim 13, wherein the reflection film is a metal reflecting coating chosen from the group consisting of an aluminum coating, a gold coating and a silver coating.

15. The reflective display device of claim 9, wherein the light emitting module comprises three LED emitters for respectively emitting red, green and blue, and a condenser lens is arranged between the light emitting module and the scanning mirror.

16. The reflective display device of claim 9, wherein the light emitting module comprises three laser sources for respectively emitting red, green and blue light.
